(19) United States
(12) Patent Application Publication
(10) Pub. No.: US 2009/0287895 A1
(43) Pub. Date: Nov. 19, 2009

(54) Secure Memory Access System

(75) Inventors: Denis Foley, Shrewsbury, MA (US); Aris Balatsos, Markham (CA)

Correspondence Address: ADVANCED MICRO DEVICES, INC.;C/O VEDDER PRICE P.C., 222 N.LASALLE STREET, CHICAGO, IL, 60601, US

(73) Assignee: Advanced Micro Devices, Sunnyvale, CA (US)

(21) Appl. No.: 12/121,573

(22) Filed: May 15, 2008

(51) Int. Cl. G06F 12/14; G06F 13/28

(52) U.S. Cl. 711/163; 710/22; 711/E12.091

(57) ABSTRACT

A secure memory access system includes a memory control module, at least one direct memory access module, and a plurality of input/output interface modules. The direct memory access module is operative to transfer information between all of the input/output interface modules and the memory control module in response to transfer configuration information.

### FIELD

The present disclosure generally relates to memory access, and more particularly, to transferring secure information between memory and one or more input/output peripherals.

### BACKGROUND

Many modern devices, such as personal computers, laptops computers, personal digital assistants, media playing and/or recording devices, cell phones, and other suitable devices, store and utilize secure information. Secure information can include, for example, digital rights management content (e.g. video, audio, game content, etc.), financial information (e.g. personal accounts, transactional information, etc.), private information (e.g. schedules, contact lists, etc.) and other suitable information. In addition, secure information can be used to bind a cellular phone to a particular network. As such, protection of the secure information is important to prevent, among other things, content and device theft.

In order to protect such secure information, it is important to control transfer of information between input/output peripherals and memory containing the secure information. In one method, a processor switches into and out of a trusted mode of operation in order to transfer information between the input output peripherals and the memory containing the secure information. However, switching the processor into and out of the trusted mode of operation to transfer information is time consuming.

As such, it is desirable, among other things, to provide a system for transferring secure information between an input/output peripheral and memory that does not require a processor to switch into and out of a trusted mode of operation.

### BRIEF DESCRIPTION OF THE DRAWINGS

The disclosure will be more readily understood in view of the following description when accompanied by the below figures, wherein like reference numerals represent like elements:

FIG. 1 is an exemplary functional block diagram of a system having a secure memory access system of the present disclosure;

FIG. 2 is an exemplary functional block diagram of the secure memory access system; and

FIG. 3 is an exemplary functional block diagram of a device having the secure memory access system.

### DETAILED DESCRIPTION

In one example, a secure memory access system includes a memory control module, at least one direct memory access module, and a plurality of input/output interface modules. The direct memory access module transfers information between all of the input/output interface modules and the memory control module in response to transfer configuration information. The transfer information can include, among other things, source address information, destination address information, packet size information, and other suitable information.

Among other advantages, the secure memory access system provides a layer of security between all of the I/O peripherals and memory. Furthermore, access to secure memory space is transparent to both the direct memory access module and all of the I/O peripherals. As such, the I/O peripherals do not need to be transitioned into and out of a trusted mode of operation as required by prior art security schemes. Other advantages will be recognized by those of ordinary skill in the art.

In one example, the secure memory access system includes memory, operatively coupled to the memory control module, that includes secure storage space. The direct memory access module transfers information between all of the input/output interface modules and the secure storage space in response to the transfer configuration information.

In one example, the secure memory access system includes at least one processing module. The processing module selectively provides the transfer configuration information based on trusted interface information. The trusted interface information includes address information for at least a portion of the input/output interface modules. As such, the processing module provides the transfer configuration information for the portion of input/output interface modules in response to an information transfer request. In one example, a register stores the trusted interface information.

As used herein, the term “module” can include an electronic circuit, one or more processors (e.g., shared, dedicated, or group of processors such as but not limited to microprocessors, DSPs, or central processing units) and memory that execute one or more software or firmware programs, combinational logic circuits, an ASIC, and/or other suitable components that provide the described functionality. Additionally, as will be appreciated by those of ordinary skill in the art, the operation, design, and organization, of a “module” can be described in a hardware description language such as Verilog™, VHDL, or other suitable hardware description languages.

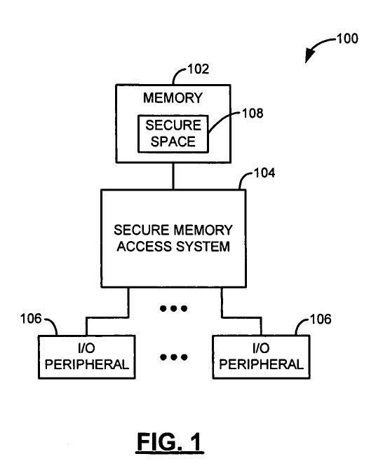

Referring now to FIG. 1, an exemplary functional block diagram of a system 100 is depicted. The system 100 includes memory 102, a secure memory access system 104, and one or more input/output (I/O) peripheral devices 106. The memory 102 includes one or more secure storage spaces 108 for storing secure information. In one embodiment, the memory 102 can include 24 secure storage spaces 108. The memory 102 can be any suitable memory such as volatile, nonvolatile, and/or any other suitable memory capable of having a secure storage space for storing secure information. The I/O peripheral devices 106 can be any suitable peripheral device such as a USB device, a UART device, an SD/SDIO/MMC/CE-ATA channel device, a NAND flash support device, a SPI interconnect device, an I2S device, an I2C device and any other suitable I/O peripheral device.

During operation, the secure memory access system 104 transfers information between the memory 102 and the I/O peripherals 106. In addition, the secure memory access system 104 selectively transfers secure information between the I/O peripherals 106 and the secure space 108 based on trusted interface information, which can be stored within the secure memory access system 104. Because the secure memory access system 104 selectively transfers secure information between the I/O peripherals 106 and the secure space 108, access to the secure space 108 is transparent to the I/O peripherals 106. In addition, the secure memory access system 104 becomes a single point of access to memory 102, which makes it easier to control access to the secure space 108.

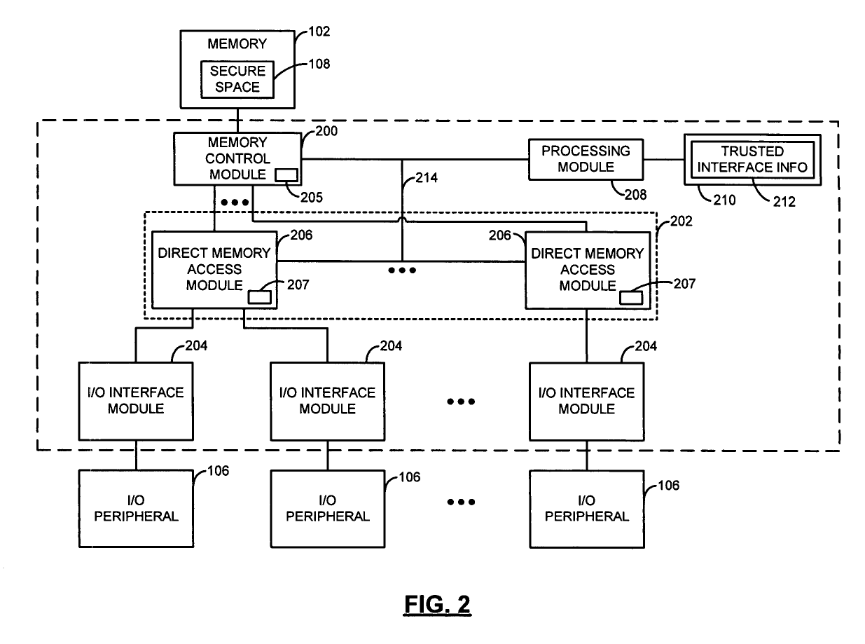

Referring now to FIG. 2, the secure memory access system 104 includes a memory control module 200, a memory access module 202, and one or more I/O interface modules 204. The I/O interface modules 204 can be any variety of suitable interfaces such a USB interface, a UART interface, a SD/SDIO/MMC/CE-ATA channel interface, a NAND flash support interface, a SPI interface, an I2S interface, an I2C interface or other suitable interface. The memory control module 200 can be any suitable memory control module known in the art capable of controlling information flow into and out of the memory 102. The memory control module 200 can include a memory secure space register 205. The memory secure space register 205 stores information used to define the secure space 108 of the memory 102.

The memory access module 202 can include one or more direct memory access modules 206. In addition, in some embodiments, one or more of the I/O interface modules 204 can include one or more of the direct memory access modules 206. Each of the direct memory access modules 206 include one or more direct memory access registers 207 that receive and store transfer configuration information used to transfer information between the memory control module 200 and the I/O interface modules 204.

The memory access module 202 is operatively coupled to the control module 200 and all of the I/O interface modules 204. As such, the direct memory access modules 206 are operatively coupled to the I/O interface modules 204. Each of the I/O interface modules 204 is operatively coupled to a respective one of the I/O peripherals 106. The memory control module 200 is operatively coupled to the memory 102.

The secure memory access system 104 also includes a processing module 208 and a trusted I/O peripheral register 210. The processing module 208 is operatively coupled to the memory control module 200, the trusted I/O peripheral register 210, and the direct memory access modules 206 of the memory access module 202.

The trusted I/O peripheral register 210 includes trusted interface information 212. The trusted interface information 212 can include, among other things, addresses defining the secure space 108, a list of I/O peripherals 106 (or I/O interface modules 204) deemed trusted (and/or non-trusted in some embodiments), and permissions (e.g. read, write, read-write) associated with the listed I/O peripherals 106 (or I/O interface modules 204). In one embodiment, the processing module 208 can access the trusted interface information 212 when it is operating in a trusted mode of operation.

The processing module 208 uses the trusted interface information 212 to determine whether a particular I/O peripheral 106 (or in some embodiments a particular I/O interface module 204) is trusted and therefore can exchange secure information with the secure space 108. The processing module 208 can also use the trusted interface information 212 to control the type of exchange (e.g. read, write, read-write) based on the permissions associated with the particular I/O peripheral 106 (or I/O interface modules 204).

During operation, the processing module 208 selectively provides transfer configuration information 214 (e.g. source address information, destination address information, packet size, etc.) to the direct memory access modules 206 in response to an information transfer request from one or more of the I/O peripherals 106 (e.g. via a respective one of the I/O interface modules 204). In one embodiment, the processing module 208 provides the transfer configuration information 214 when it is in a trusted mode of operation.

The processing module 208 provides transfer configuration information 214 based on the trusted interface information 212. For example, if one of the I/O peripherals 106 (or I/O interface modules 204) requests access to the secure space 108 and that particular I/O peripheral 106 (or I/O interface modules 204) is defined in the trusted interface information 214, the processing module 208 provides the transfer configuration information 214. However, if in this example, that particular I/O peripheral 106 (or I/O interface modules 204) is not defined in the trusted interface information 214, the processing module 208 does not provide the transfer configuration information 214. Those of ordinary skill in the art will appreciate that rather than defining particular I/O peripherals 106 (or I/O interface modules 204) deemed to be trusted within the trusted interface information 214, particular I/O peripherals 106 (or I/O interface modules 204) that are deemed to be non-trusted can be defined if desired.

In addition, if for example, one of the I/O peripherals 106 (or I/O interface modules 204) requests to access other areas of the memory 102 (e.g. non-secure space), the processing module 208 provides the transfer configuration information 214 to the memory access module 202 in response to the information transfer request without regard to the trusted interface information 212.

The memory access module 202 transfers information between all of the I/O peripherals 106 and the memory control module 200 in response to the transfer configuration information 214. More specifically, a respective one of the direct memory access modules 206 transfers information between all of the respective I/O interface modules 204 and the memory control module 200 in response to the transfer configuration information 214. In addition, as previously noted, the processing module 208 provides the transfer configuration information 214 to the memory access module 202 in response to requests from the I/O peripherals 106 (or I/O interface modules 204) included in the trusted interface information 212. As such, the memory access module 202 (e.g. a respective one or more direct memory access modules 206) transfers information between all of the I/O peripherals 106 (or all of the I/O interface modules 204) and the secure space 108 in response to the trusted configuration information 214.

In this manner, the secure memory access system 104 efficiently manages I/O peripheral 106 access to the secure space 108 within the memory 102. Because the secure memory access system 104 manages access to the secure space 108, none of the I/O peripherals 106 have direct access to the secure space 108. As such, a layer of security between all of the I/O peripherals 106 and the secure space 108 is provided. Furthermore, access to the secure space 108 is transparent to the I/O peripherals 106 due to the processing module 208 selectively providing the transfer configuration information 214 based on the trusted interface information 212. Because access to the secure space 108 is transparent to the I/O peripherals 106, they do not need to transition into and out of a secure mode of operation as required by prior art security schemes.

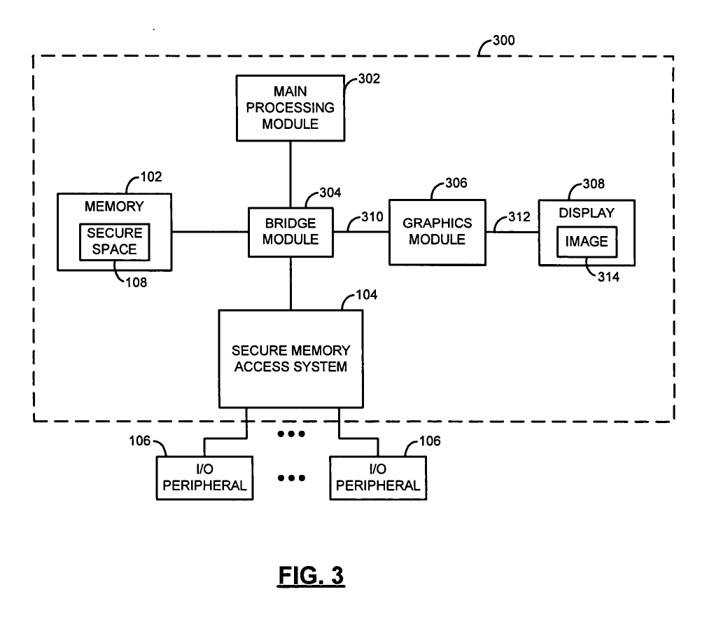

Referring now to FIG. 3, a device 300 using the secure memory access system 104 is depicted. The device 300 can be any suitable device such as, for example, a personal computer, a laptop computer, a personal digital assistant, a media playing and/or recording device, a cellular phone, and/or any other suitable device having I/O peripherals that may access a secure space within memory. In this example, the device includes the memory 102 (including the secure space 108), a main processing module 302, a bridge circuit 304, a graphics module 306 (e.g. graphics processing unit), and a display 308. The main processing module 302 can be any suitable processing circuit such as, for example, a central processing unit. In some embodiments, it may be desirable to have a single processor rather than the processing module 208 of the secure memory access system 104 and the main processing module 302. Therefore, the functionality of the processing module 208 can be carried out by the main processing module 302 if desired.

The bridge circuit 304 is operatively coupled to the main processing module 302, the memory 102, the secure memory access system 104, and the graphics module 306. The bridge circuit 304 transfers information (e.g. data and control) between the respective components to which it is operatively coupled. As known in the art, the graphics module 306 receives graphics information 310 and provides display information 312 based thereon. The display 308, which can be any suitable display such as an LCD, LED, CRT, plasma, or other suitable display, provides an image 314 that can be viewed by a user in response to the display information 312.

The device 300, when connected to one or more I/O peripherals 106, can transfer information between the memory 102 and all the peripherals 106 via the secure memory access system 104. In this manner, the secure memory access system 104 can selectively transfer information between the secure space 108 and one or more of the I/O peripherals 106 based on the trusted interface information 212.

As noted above, among other advantages, the secure memory access system 104 provides a layer of security between all of the I/O peripherals 106 and the secure space 108. Furthermore, access to the secure space 108 is transparent to the I/O peripherals 106 due to the processing module 208 selectively providing the transfer configuration information 214 based on the trusted interface information 212. As such, access to the secure space 108 is transparent to the I/O peripherals 106 and they do not need to transition into and out of a secure mode of operation as required by prior art security schemes. Other advantages will be recognized by those of ordinary skill in the art.

Also, integrated circuit design systems (e.g., work stations) are known that create integrated circuits based on executable information stored on a computer readable memory such as but not limited to CDROM, RAM, other forms of ROM, hard drives, distributed memory etc. The information may include data representing (e.g., compiled or otherwise represented) any suitable language such as, but not limited to, hardware descriptor language or other suitable language. As such, the “module” described herein may also be produced as integrated circuits by such systems. For example an integrated circuit may be created for use in a display using information stored on a computer readable medium that when executed cause the integrated circuit design system to create a secure memory access system that includes a memory control module, at least one direct memory access module, and a plurality of input-output interface modules. The direct memory access module transfers information between all of the input/output interface modules and the memory control module in response to trusted configuration information. Integrated circuits having a “module” that performs other operations described herein may also be suitable produced.

While this disclosure includes particular examples, it is to be understood that the disclosure is not so limited. Numerous modifications, changes, variations, substitutions, and equivalents will occur to those skilled in the art without departing from the spirit and scope of the present disclosure upon a study of the drawings, the specification, and the following claims.

What is claimed is:

1. A secure memory access system, comprising:
a memory control module;
at least one direct memory access module; and
a plurality of input/output interface modules, wherein the at least one direct memory access module is operative to transfer information between all of the plurality of input/output interface modules and the memory control module in response to transfer configuration information.

2. The secure memory access system of claim 1 further comprising memory, operatively coupled to the memory control module, that comprises secure storage space, wherein the at least one direct memory access module is operative to transfer information between all of the plurality of input/output interface modules and the secure storage space in response to transfer configuration information.

3. The secure memory access system of claim 1 further comprising at least one processing module that is operative to selectively provide transfer configuration information based on trusted interface information.

4. The secure memory access system of claim 3 wherein the trusted interface information comprises address information for at least a portion of the plurality of input/output interface modules.

5. The secure memory access system of claim 4 wherein the at least one processing module is operative to provide transfer configuration information for the portion of the plurality of input/output interface modules in response to an information transfer request.

6. The secure memory access system of claim 3 further comprising at least one register that is operative to store the trusted interface information.

7. The secure memory access system of claim 1 wherein the transfer configuration information includes at least one of source and destination address information.

8. A secure memory access system, comprising:
at least one direct memory access module; and
a plurality of input/output interface modules, wherein all of the plurality of input/output interface modules are operatively coupled to the at least one direct memory access module.

9. The secure memory access system of claim 8 further comprising a memory control module operatively coupled to the at least one direct memory access module.

10. The secure memory access system of claim 9 further comprising memory operatively coupled to the memory control module, wherein the memory comprises secure storage space.

11. The secure memory access system of claim 8 further comprising at least one processing module operatively coupled to the least one direct memory access module.

12. The secure memory access system of claim 11 further comprising at least one register operatively coupled to the at least one processing module, wherein the at least one register is operative to store trusted interface information.

13. A device, comprising:
memory;
a secure memory access system that comprises:
a memory control module operatively coupled to the memory;
at least one direct memory access module; and
a plurality of input/output interface modules, wherein the at least one direct memory access module is operative to transfer information between all of the plurality of input/output interface modules and the memory control module in response to transfer configuration information; and
a display that is operative to provide an image based on information stored in the memory.

14. The device of claim 13 wherein the memory comprises secure storage space and the at least one direct memory access module is operative to transfer information between all of the plurality of input/output interface modules and the secure storage space in response to transfer configuration information.

15. The device of claim 13 further comprising at least one processing module that is operative to selectively provide transfer configuration information based on trusted interface information.

16. The device of claim 15 wherein the trusted interface information comprises address information for at least a portion of the plurality of input/output interface modules.

17. The device of claim 16 wherein the at least one processing module is operative to provide transfer configuration information for the portion of the plurality of input/output interface modules in response to an information transfer request.

18. The device of claim 15 further comprising at least one register that is operative to store the trusted interface information.

19. the device of claim 15 wherein the transfer configuration information includes at least one of source and destination address information.

20. A computer readable medium comprising information that when executed by at least one processor causes the at least one processor to:
at least one of: operate, design, and organize a circuit that comprises:
at least one direct memory access module; and
a plurality of input/output interface modules, wherein all of the plurality of input/output interface modules are operatively coupled to the at least one direct memory access module.

21. A method of accessing secure memory, comprising:
selectively providing transfer configuration information based on trusted interface information; and
using a direct memory access module to transfer information between all of a plurality of input/output interface modules and a memory control module in response to the transfer configuration information.
